(19) United States
(12) Patent Application Publication
(10) Pub. No.: US 2012/0198324 A1
(43) Pub. Date: Aug. 2, 2012

(54) Systems, Methods, and Apparatuses to Write on Web Pages

(76) Inventors: Ruchi Mahajan, Sunnyvale, CA (US); Pratik Bansal, Sunnyvale, CA (US)

(21) Appl. No.: 13/360,654

(22) Filed: Jan. 27, 2012

Related U.S. Application Data
(60) Provisional application No. 61/436,974, filed on Jan. 27, 2011.

(51) Int. Cl. G06F 17/00

(52) U.S. Cl. 715/230

(57) ABSTRACT

The embodiments of the present invention provide novel systems and methods for providing notation of webpages and implementing real-time communication mechanisms around such notations. The embodiments enable a user to comment of webpages and share such content with other users.

### RELATED APPLICATIONS

This application claims priority from U.S. Provisional Patent Application Ser. No. 61/436,974, filed Jan. 27, 2011, which is incorporated herein by reference in its entirety for all purposes.

### FIELD OF THE INVENTION

The present invention relates to webpage content, and more particularly to providing tools for writing to a webpage.

### BACKGROUND

Technical innovation brought the concept of web-pages. Users used printed pages to read or write the content. Currently, there exists standard browser support for reading web-pages (similar to printed pages) however, there is no support for actually writing to a webpage—or as referred to herein “scribbling”. As a result there is a need for systems, methods and apparatuses for writing to a webpage. Embodiments of the present invention provide novel non-obvious mechanisms to comment on content and enable communication between users.

### SUMMARY

A method for providing annotations on a webpage comprising, enabling a user to compose text, posting the text to a webpage, and saving the posted text.

A system for providing annotations on a webpage comprising, a server, a database, a network, at least one client in communication with the server, the client accessing a software module which enables a user to compose text and post said text to a webpage, wherein the posted text is saved.

In one embodiment, aspects of the present invention provide support thru browser add-on/widget/bookmarklet/embedded javascript or HTML or CSS or other browser supported technologies that enables scribbling the web pages. In one embodiment a user annotates any web page content written in HTML or any other mark-up language by attaching scribbles to specific sections of a web-page

In another embodiment, scribbles for a web-page may be overlay elements that attach to the underlying Document Object Model (DOM) structure of the document. DOM being a cross-platform and language-independent convention for representing and interacting with objects in HTML, XHTML and XML documents. Aspects of the DOM (such as its “Elements” <the basic or aggregate unit of the overall document.) may be addressed and manipulated within the syntax of the programming language in use. The public interface of a DOM is specified in its application programming interface (API). Accordingly, in one embodiment, the scribbles may show up on the actual web page itself (and not copied version of the web-page or alias URLs). In such an embodiment the original web-page may optionally be embedded within an iframe whose top-most window frame may be loaded from source other than the original web-page. Although referred to herein as web-pages the intent is not to be limited and does not mean merely pages displayed on computer browsers and such reference includes any type of page represented by a mark-up language.

In one embodiment scribbles may be attached to very specific web elements on the web-page including a user scribbling a specific link, a paragraph, an HTML div element, an image, a bold/underline text, span elements, i.e., any HTML element.

The scribbles on the page can then be saved. This will result in a scribble (which includes scribble layout information, corresponding comments, associated tags and HTML element information on the corresponding URL) to be saved to servers. These scribbles can then be loaded back on the original web-page if the users requests to do so.

Other objects, advantages, and applications of the embodiments of the present invention will be made clear by the following detailed description of a preferred embodiment of the present invention. The description makes reference to drawings in which:

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIG. 1 is an embodiment of a screenshot of a user attaching a note to a webpage;

FIG. 2 is an embodiment of a screenshot depicting an exemplary representation of an HTML element being highlighted;

FIG. 3 is a screenshot of a user accessing a notes section of a webpage in accordance with one embodiment of the present invention;

FIG. 4 is a screenshot of a user completing his/her notes in accordance with the embodiment of FIG. 3;

FIG. 5 is a screenshot depicting real-time commenting/chat “hooks” for specific parts of a page in accordance with an embodiment of the present invention;

FIG. 6 is a screenshot depicting real-time commenting/chat “hooks” and a chat window for specific part of a page in accordance with an embodiment of the present invention; and

FIG. 7 is flowchart depicting a data processing system in accordance with an embodiment of the present invention.

### DETAILED DESCRIPTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments are described with respect to note and commenting on webpages, this is not intended to be a limitation on the embodiments of the present invention. It's scope is equally applicable to any software or coding in which enabling user comments is desirable. For example, aspects of the present invention may also be applied to videos, movies, and text and graphics on a display.

In accordance with the embodiment of the present invention, the structure of the Document Object Model (DOM) can be manipulated so that it is useful to a user.

The DOM structure is enabled to divide the data in a way that makes sense to a user. For example, a paragraph written within <p>some text . . . </p> is a unit of information that a user understands and is able to read to make sense of.

In another example: <p>some text . . . <b>important text</b> </p> provides for adding emphasis. In this example the ‘important text’ is in bold which has a different meaning as compared to rest of the paragraph. Here the author of the document wants you to read the paragraph as a block, however, she wants to also emphasize ‘important text’ so that it is not missed.

As another example, attaching overlays (herein after also referred to as “scribbles”) to an HTML element as a unit can provide a good way of attaching meaningful annotations to the web-pages. Some HTML units may not make much sense to users as they may have been placed by authors of the web-page for convenience. In such a case, users will tend to not attach scribbles to such portions of the web-page. Further, the aggregation of scribbles from various sources can be done for HTML elements. More relevant portions of the web-page will tend to be heavily scribbled, and vice-versa for lesser useful parts of the web-page. Such scribbling can be a useful source of information that can help software programs (like search engines) in filtering out useful content on a web page. Conceptually, the note/scribble is affixed to the page directly and could optionally be made public or private by the author or by the page provider. While the present embodiment does not include a duplicate copy of the page, this is not intended to be a limitation on the embodiments of the present invention and duplicate copes of the page could be stored or otherwise maintained. Although referred to herein and throughout, the embodiments are not limited to HTML and it is intended and contemplated within the scope that such references could refer to any mark-up language now known or hereinafter embodied.

In another embodiment of the present invention the bookmarking capabilities of the browser are enhanced. Although the term browser is used herein, it is not too be understood in the limiting sense such as just web-based or mobile based, but broadly and unlimited. For example current bookmarking features in a browser can be done only for a particular URL. While there is a general concept of HTML anchor, still such is embodied in only static links predefined by the author of the web page.

Anchor scribbling provides an option to bookmark dynamically specific sections of a web-page. For example, a user can attach a scribble (say a note) to an image (say ‘abc.gif’) or a specific comment way down the page (www.xyz.com). Once the scribble is added and saved, the scribbling system generates an anchor scribble URL which may look something like (http://www.xyz.comiliScribbledAnchor,xethh23j-rxe45dxe)

where:

‘xethh23j-rxe45dxe’ is the iscribbled anchor id.

‘xethh23j’—represents the unique web element for the URL that has been anchored.

‘rxe45dxe’—represents the unique id to the scribble written by the user.

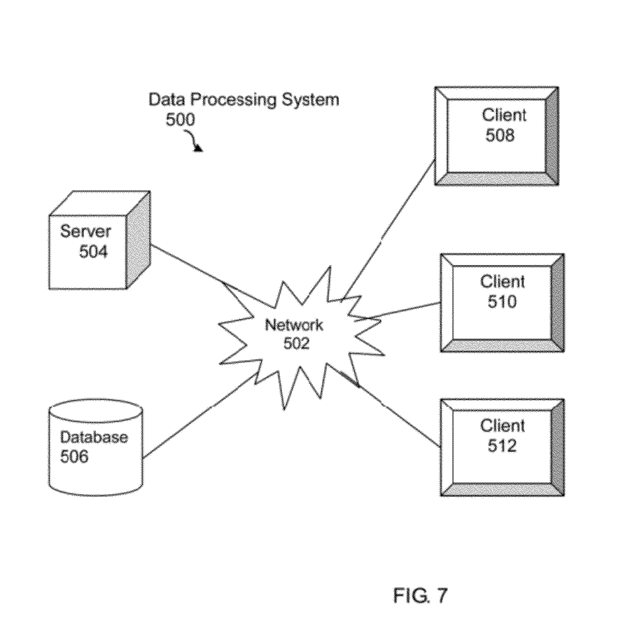

A software module, that provides for an overlay that enables a user to add comments, view comment, delete comments, add emphasis, etc. may reside on the server described below in conjunction with FIG. 7. A webpage owner may then access the software module and activate its features. Alternatively the host of a webpage may locally install such a module, also referred to herein as a local plug in. Optionally the overlay may display a menu, for example a tool bar style menu that enables users to access the features of the software module. The content added by a user may be hosted on the sever with the software module or on the webpage host or locally on by the user in the case of a plug in, or in any other appropriate locale.

In one embodiment, any user can post to any webpage which has enabled the software module. The user could also optionally control the posting by limiting access and visibility. Alternatively, the host of the webpage could control which users and/or what users can post. In the latter embodiment, the host could also control the posting by for example limiting the content, de-publishing, or further commenting as such. In contrast to community style websites which allow for co-authoring and editing, embodiments of the present invention allow users to comment, add, amend, etc., content without actually modifying the existing content itself.

In another embodiment, a user can choose not to view any comments by using the menu on the overlay module. In another embodiment the host may deactivate any user menu control.

In another embodiment, the owner of a webpage, can optionally enable the module to implement its features. Alternatively, a user may individually have a plug-in module that enables the user to access all features of the overlay module. However, in such instances, the information is not automatically overlayed on the webpage, but instead is only available to additional users the original user provides access to.

In one embodiment, the user can choose to share or send the anchor to another user. Once the other user clicks on this special URL, various scenarios including but not limited to the following may occur:

Scenario 1

the other user already has the browser add-on: In this case the browser add-on checks the URL for scribbled anchors. If it finds one, then the add-on opens the URL http://www.xyz.com, pulls the scribble from the server, attaches the scribble to the specific element on the web page and scrolls the page to center the scribbled element (in this case ‘abc.gif’). This enhances the link sharing capabilities tremendously as specific web elements scribbles can be shared across thru social media like Facebook® or Twitter®. There can be multiple scribbles in a scribble anchor URL. For example, more than one scribble can be attached on a web page and share the corresponding scribbled URL (e.g. http://www.xyz.com#iScribbledAnchor,xethh23j-rxe45dxe,rtyrngh66-yuui47j3hu) In case of multiple scribbles, all the scribbles for the corresponding page are loaded and the page scrolls to the scribbled element which is visually the first one from top down (as the user scrolls the page). This will provide bloggers/writers ability to attach comments to the original page and link to it from their web-pages instead of copying over specific sections of the content and then putting in their thoughts.

If the other user doesn't have the browser add-on, but the website operator has embedded iscribbled widget/embedded JavaScript to his page, the results will be same as above. The rendering notes may happen thru any mechanism and is not so limited to JavaScript, HTML5, CSS, and such are contemplated within the scope of the embodiments. JavaScript is used merely as a reference mechanism.

Scenario 2

The other user doesn't have the add-on installed nor the website operator embedded iscribbled widget or JavaScript: In this case the browser just ignores the URL section after ‘#’ and opens up the URL www.xyz.com. This is currently the best you can achieve today with regular book-marking tools.

In another instance:

The other user types in the URL: http://www.xyz.com#iScribbledAnchor,xethh23j i.e., enabling direct access to the comments by including missing anchor portion after ‘-’. In this case all the scribbles or the most voted scribbles attached to the web-element are loaded. The decision making can be based on various factors including but not limited to popularity, randomly, all scribbles, and is up to the page provider to decide.

Scenario 3

In another example, the URL generated can point to another URL which embeds an iframe that opens the original URL and overlays these scribbles on it. In this case the iscribbled anchor URL can be of form: www.abc.com?origURL=www.xyz.com#iScribbledAnchor,xethh23j-rxe45dxe. The browser will open www.abc.com which may embed the original URL (www.xyz.com) in an iframe—following which, the script on www.abc.com can run and embed the scribble on www.xyz.com.

Scenario 4

In another example, the URL being scribbled upon is already having a static HTML anchor. In such a case, the generated dynamic anchor will displace or remove the original static anchor from the URL and attach the dynamic anchor instead.

Sharing can be completed by either the author of the scribble initiating the sharing (via dynamic anchors) or alternatively the web-page provider may like the comment and choose to automatically display it on his/her page.

Scribble Tags

In one embodiment, users tag scribbles with key words to help categorize/search scribbles later. Scribble tags can be useful source of information for web crawlers/Advertisers to categorize or rate specific sections of any web-page. For example if a user scribbled an image xyz.gif with tag ‘Apple’, then the web crawlers can use this tag to categorize the image appropriately. Currently, the only mechanism available to do this is via Alt tags for image or using AI algorithms to match image to set of known images. Alt tags are pretty much static and based on what the author of HTML page has written. The scribbling will provide a mean to dynamically attach tags to specific web elements.

In another embodiment, users can scribble questions on specific parts of a web-page. For example, a user is reading oracle database user manual, page xxx. The user is not clear about certain text in one of the paragraphs. The user is then able to scribble a question on that paragraph. The question may be published to other people (say experts) on the subject and they can choose to provide answers/better explanation. This is different from the way question-answer websites operate today where the source of the question, i.e., the user, the subject (oracle user manual) and the subject experts meet at another venue (e.g. question/answer website). The commenting also referred to as “scribble” enables the user to raise questions and brings the source of question and the subject experts to the subject instead of the other way around.

In one embodiment real-time commenting/chatting is provided, wherein the chat applies optionally to only that marked-up element. The web page may have multiple of such chat sessions, each one relevant to the DOM element it is attached to.

In a non-limiting example, one application is a game of cricket, where a real-time chat window opens for every ball being bowled. Users following the cricket commentary can place their comments by clicking on chat icon next to ball or by attaching note to the DOM element holding the commentary for the ball. Here every ball, for instance, can display in its own div/span element. In essence, the users would be discussing the game ball-by-ball in this example.

In another non-limiting example, a student in class could attach scribbles to specific part of mark-up based lecture notes (say he/she has a question or needs clarification on some or whole part). These scribbles can then display on other students and professors browser in real-time during the lecture time. This can result in opening up a chat session for that part of the lecture note, for other people viewing the same page, and they can chime in.

The above provided examples are non-limiting are various other embodiments of the use of chatting is contemplated within the scope of the present embodiments including but not limited to discussions on specific parts of politically sensitive web-page to doctors discussing a case on a HTML document via chat part-by-part.

Conceptually and practically, these chat sessions are individual scribbles aggregated and displayed in a chat-like window. The usual scribble rules described herein apply to individual chat comments.

Currently, web pages may lack human emotions or feelings. In one embodiment, scribbles can be used to express what the user thinks or feels about specific parts of a page. For example, a user could attach a ‘humorous’ scribble to a web element that the user finds humorous and share it on social media. Similarly, a user can scribble ‘sad’ if some images make him feel sad. A plagiarized, useful or original content can be scribbled accordingly. All this information can collectively be used to categorize a web-page content for the search engine. This will be a tool to capture people's collective emotions for a web page.

In another embodiment, a user can connect individual scribbles together using “Scribble Connectors.” Scribble Connectors enable a user to connect similar web elements together as described below. This further expands the capability of scribble tags.

As a non-limiting example: A user is reading something about apples which the user finds very interesting on www.goodtextapple.com. However on another URL (www.goodimageapple.com) the user finds a good image of apple. The user can scribble the text on www.goodtextapple.com and ‘connect’ it to image at ‘www.goodimageapple.com’. This will help the user prepare personal notes.

There are reasons to not just copy over the entire content to another web-page instead of implementing “scribbling”.

There are several advantages to implementing the novel systems and methods herein, including but not limited to: enabling users to view links as pointers to information at the source. By providing an original link, the user attributes the information to the original source.

Further scribbling the original content is important because this enables a user to always see the current/most updated content directly from the source. Many blogs have active comments being updated on the original web-page. Users for most part would want to see the content being scribbled on directly at the source. This not only helps in reducing content duplication, but also gives the users the full context around the content being discussed.

In the example link above (using iscribbled anchor)—http://www.xyz.com#iScribbledAnchor, xethh23j-rxe45dxe.

The link ‘http://www.xyz.com#iScribbledAnchor, xethh23j’ belongs to the website-operator, while the link ‘http://www.xyz.com#iScribbledAnchor, xethh23j-rxe45dxe’ belongs to the scribble contributor.

In another embodiment the dynamic anchors are embedded on other web pages that reference these dynamic anchors. In such a case, the specific content being referenced, along with accompanying annotation (if any), can be displayed on the referencing page. This display could happen automatically or on mouse-over or any triggered event using embedded javascript or other programming languages/mechanisms.

For example a blogger throws an anchor on some page http://www.being-referenced.com#iScribbledAnchor,abc-def. The text being scribbled in this case corresponds to a div element (say) ‘<div>I am being scribbled</div>’, the comment text by blogger being “I am the comment text”. The blogger then uses this link (which contains dynamic anchor) in one of her blog pages. When a mouse-over happens on that link on the blog page a text bubble/box could appear that would show the context “I am being scribbled” (orig source: http:www.being-referenced.com), along with some meta information (author name, date created etc.), followed by the author's comments—“I am the comment text”. This will help the web-page linking (using dynamic anchor) to original source to show a quick snapshot of specific content being referenced.

If the dynamic anchor contains Multiple scribbles, all contexts (e.g. ‘I am being scribbled’) along with attached comments are shown in any defined order or unordered. If one element is attached to multiple comments, then the element context appears just once, followed by comments in any predefined order or unordered.

Embodiments of the present invention also take into consideration web page changes. In one embodiment, if the page changes then scribble links become invalid. The situation is similar to bookmarks that become invalid once the page URL changes. However, while not preferred, the content may be maintained in an Internet archive such as the “wayback machine”, or an internal server.

Aspects of the present invention may be implemented on one or more computers executing software instructions. According to one embodiment of the present invention, server and client computer systems transmit and receive data over a computer network or a fiber or copper-based telecommunications network. The steps accessing, downloading, and manipulating the data, as well as other aspects of the present invention are implemented by central processing units (CPU) in the server and client computers executing sequences of instructions stored in a memory. The memory may be random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one of more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or client computers. In some instances, the client and server functionality may be implemented on a single computer platform.

Aspects of the present invention can be used in a distributed electronic commerce application that included a client/server network system that links one or more server computers to one or more client computers. The client and server computers may be implemented as desktop personal computers, workstation computers, mobile computers, portable computing devices, personal digital assistant (PDA) devices, cellular telephones, digital audio or video playback devices, or any other similar type of computing device. For purpose of the following description, the terms “computer network” and “online” may be used interchangeably and do not imply a particular network embodiment or topography. In general, any type of network (e.g., LAN, WAN, or Internet) may be used to implement the online or computer networked implementation of the software.

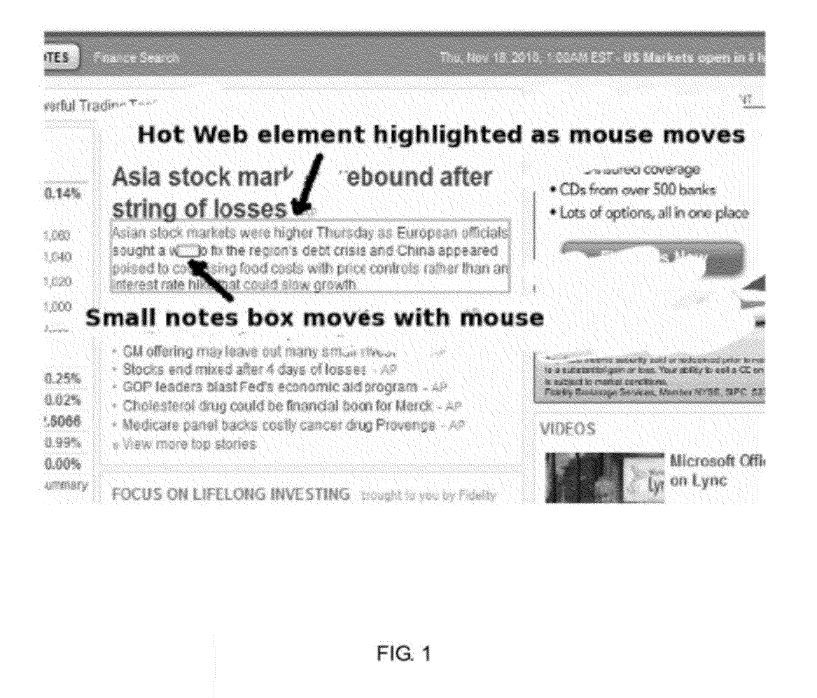

With reference now to the figures, and in particular FIG. 1. FIG. 1 is a screenshot depicting a representation of a user trying to “attach a note” on a webpage. As shown, a small notes box moves along with mouse. The HTML element to which the scribble will be attached is highlighted. The note hasn't attached yet. FIG. 1 is exemplary only and not as a limitation for the present invention.

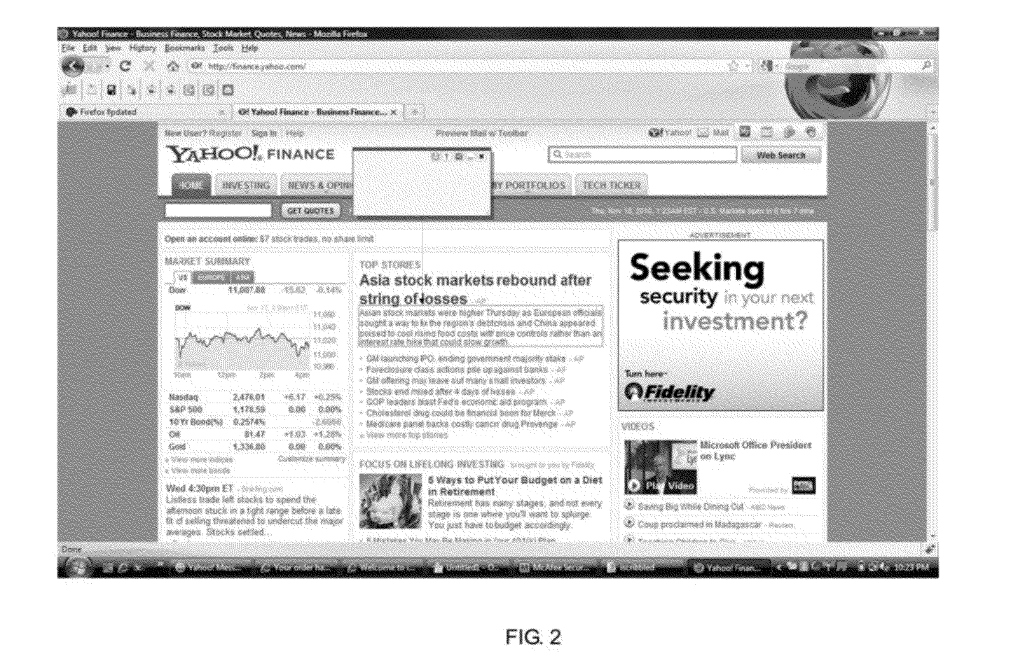

FIG. 2 is a screenshot of an exemplary representation of the HTML element being highlighted is selected after a single “click” of the mouse. The user then drags the mouse (in down position) and finally leaves the expanded note at the desirable position. The dragging action of mouse is not necessary. The note could just expand on single click or any other variation may be present. Again, FIG. 2 is intended as an example and not as a limitation for the present invention.

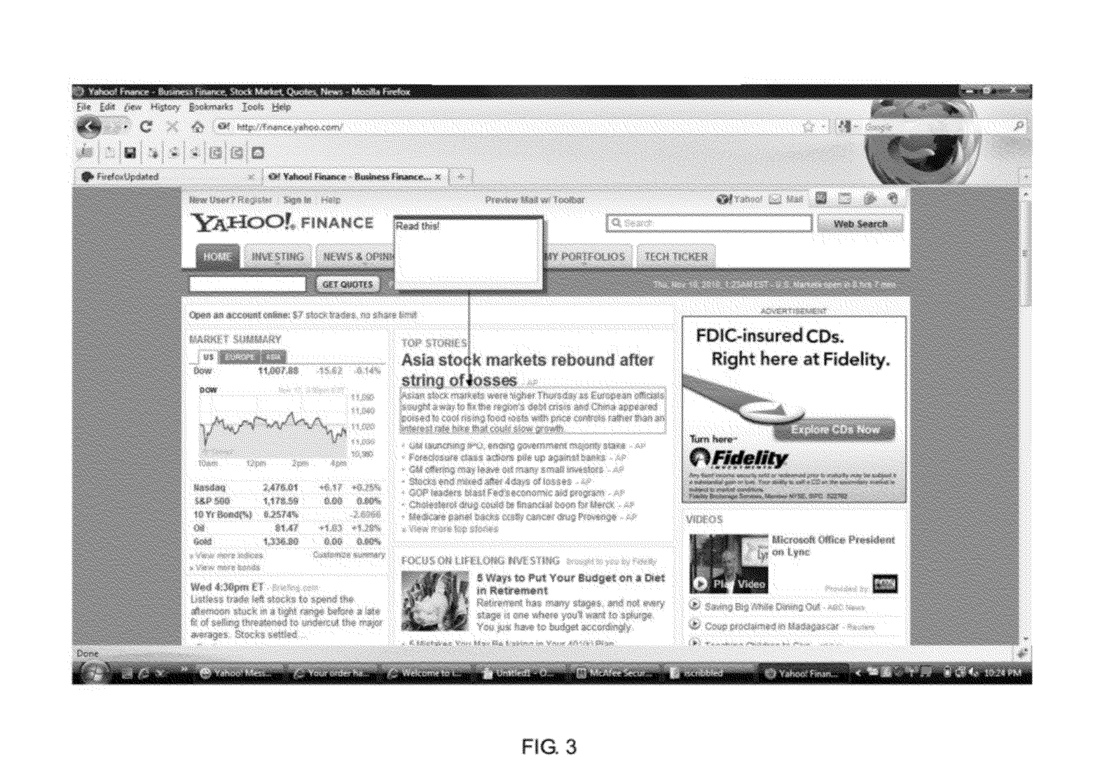

FIG. 3 shows a screenshot of an exemplary representation of a user double-clicking on the Notes section. As a result, the area becomes editable. The user is then able to type her notes.

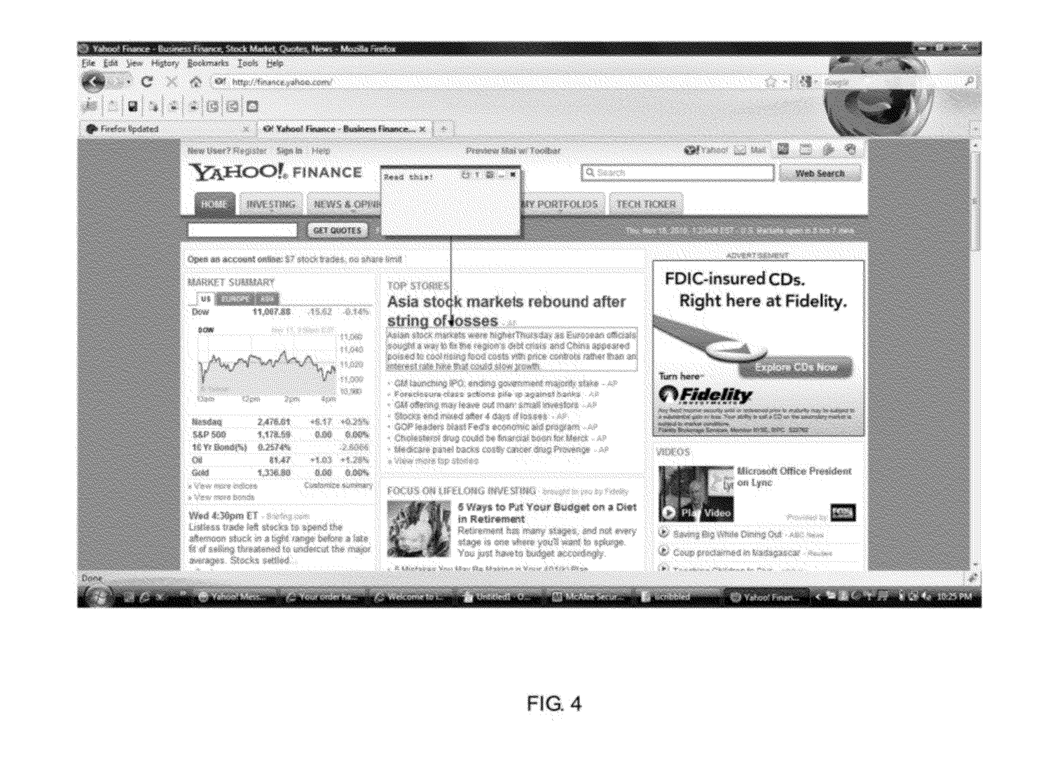

FIG. 4 shows a screenshot of an exemplary representation of a user completing his/her notes. As shown after the notes are completed, the user clicks anywhere outside of Notes area.

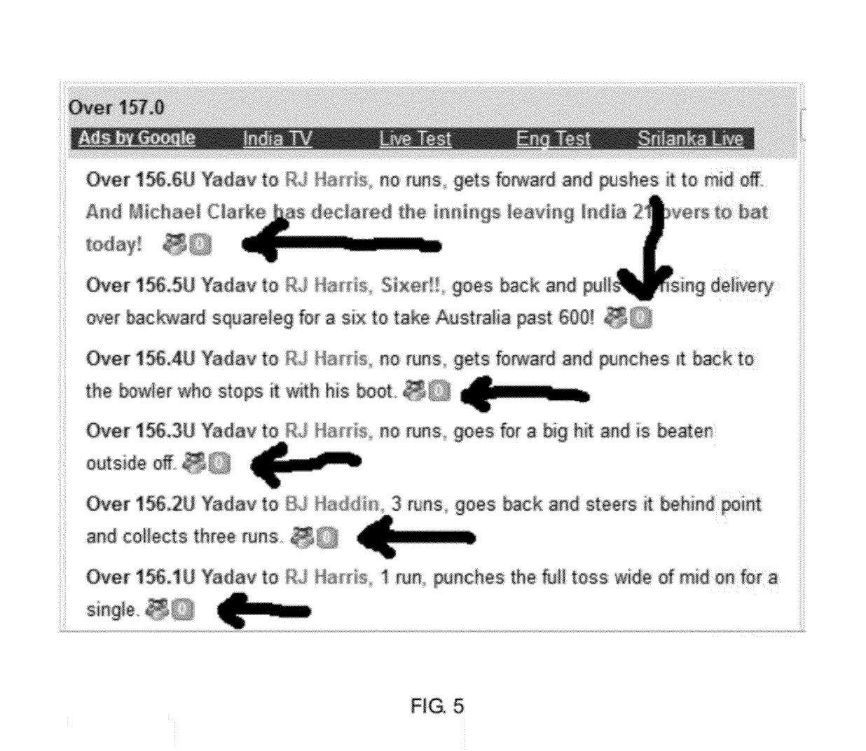

FIG. 5 is a screenshot of an exemplary representation showing real-time commenting/chat “hooks” for specific parts of a page. Optionally, there may be an indicator of the number of comments, as shown herein as the number displayed within the orange circles.

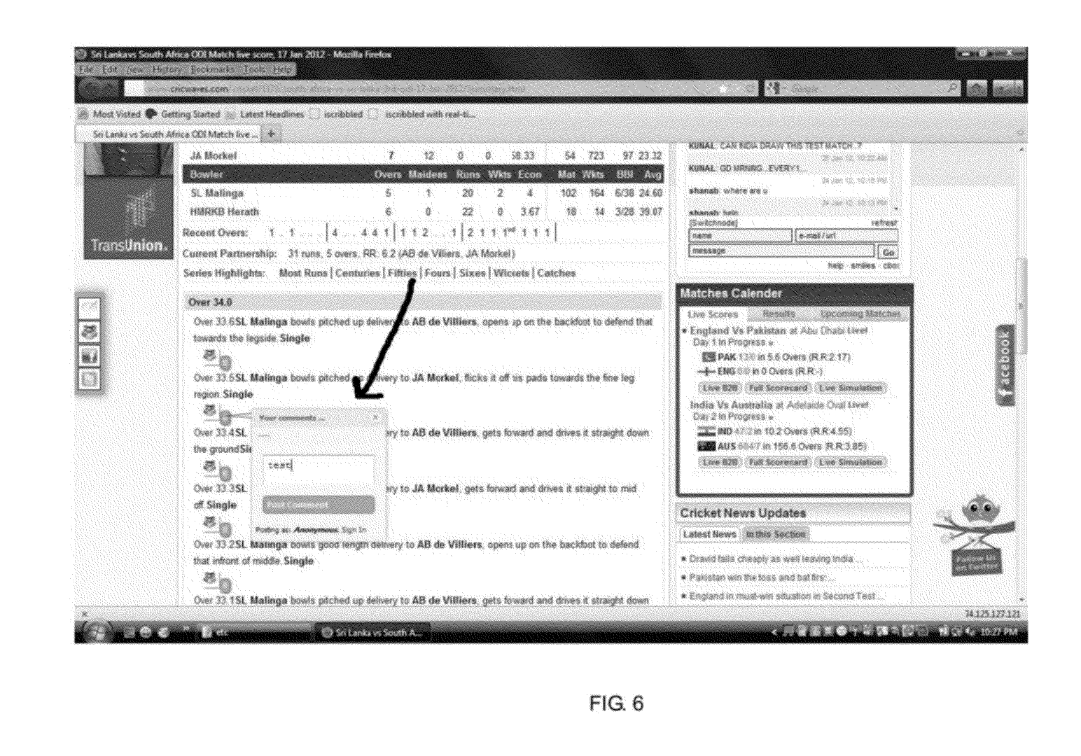

FIG. 6 is a screenshot of an exemplary representation showing real-time commenting/chat “hooks” and a chat window for specific parts of a page. The user can type his/her comment in the text area and post comment to the chat stream. The comment is relevant only to the part of web-page chat window is attached to.

FIG. 7 is an exemplary pictorial representation of a data processing system which may be implemented in accordance with an embodiment of the present invention. FIG. 7 is exemplary in nature and is not intended to be an architectural limitation of the processes of the embodiments of present invention.

Data processing system 700 is a network of computers in which embodiments of the present invention may be implemented. Data processing system 700 comprises a network 702, which is the medium used to provide communications links between various devices and computers connected within data processing system 700. Network 702 may include permanent connections, such as wire or fiber optic cables, or temporary connections made through telephone connections, or make be coupled through various connections as now know or hereinafter known.

In the depicted example, server 704 is coupled to network 702, along with storage unit 706. In addition, clients 708, 710 and 712 are also coupled to network 702. Clients, 708, 710 and 712, may be, for example, personal computers or network computers. For purposes of the present embodiment, a network computer is any computer coupled to a network which receives a program or other application from another computer coupled to the network. In the depicted example, server 704 provides data, such as boot files, operating system images and applications, to clients 708-712. Clients 708, 710 and 712 are clients to server 704. Data processing system 700 may include additional servers, clients, and other devices not shown.

In the present embodiment, data processing system 700 is the Internet, with network 702 representing a worldwide collection of networks and gateways that use the TCP/IP suite of protocols to communicate with one another. Although described as a TCP/IP protocol, this is not intended to be a limitation on the embodiments of the present invention and other protocols are contemplated within the scope. At the heart of the Internet is a backbone of high-speed data communication lines between major nodes or host computers consisting of thousands of commercial, government, education, and other computer systems that route data and messages. Distributed data processing system 700 also may be implemented as a number of different types of networks such as, for example, an intranet or a local area network.

Although the data processing system 700 is depicted as having a server, a database, and three clients acting through a single network, this is not intended to be a limitation on the embodiments of the present invention. Multiple servers, databases, networks and clients are contemplated within the scope of the embodiments of the present inventions. Further, although the client is described as a computer, such is not intended to be a limitation on the embodiments of the present invention. Smartphones, PDAs, netbooks, electronic tablets, mobile devices, and any other device capable of communication is contemplated within the scope of embodiments of the present invention. Similarly, the network is not limited and includes any system capable of communication.

As noted previously the forgoing descriptions of the specific embodiments are presented for purposes of illustration and description. They are not intended to be exhaustive or to limit the invention to the precise forms disclosed and obviously many modifications and variations are possible in view of the above teachings. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

What is claimed is:

1. A method for providing annotations on a webpage comprising:
enabling a user to compose text;
posting the text to a webpage; and
saving the posted text.

2. The method of claim 1, further comprising:
attaching the posted text to a specific element on the webpage

3. The method of claim 1, further comprising:
displaying the posted text to other users.

4. The method of claim 2, wherein the posted text is placed in a chat window.

5. The method of claim 1, further comprising
saving the posted text to a database.

6. A system for providing annotations on a webpage comprising:
a server;
a database;
a network;
at least one client in communication with the server;
the client accessing a software module which enables a user to compose text and post said text to a webpage;
wherein the posted text is saved.
